(19) United States
(12) Patent Application Publication
(10) Pub. No.: US 2021/0199946 A1
(43) Pub. Date: Jul. 1, 2021

(54) MEASURING ARRANGEMENT, LIGHT MICROSCOPE AND MEASURING METHOD FOR IMAGING DEPTH MEASUREMENT

(71) Applicant: Carl Zeiss Microscopy GmbH, Jena (DE)

(72) Inventor: Alexander GAIDUK, Jena (DE)

(73) Assignee: Carl Zeiss Microscopy GmbH, Jena (DE)

(21) Appl. No.: 17/117,773

(22) Filed: Dec. 10, 2020

(30) Foreign Application Priority Data
Dec. 20, 2019 (DE) 102019135521.4

(51) Int. Cl. G02B 21/36; G02B 21/00

(52) U.S. Cl. CPC G02B 21/367; G02B 21/0032; G02B 21/008

(57) ABSTRACT

An object is arranged in a measurement region at an objective. In addition, an imaging arrangement which comprises the objective or is connected thereto by means of an objective holder is configured to image light emanating from the object for a plurality of object planes with respect to the object to form a wide-field intermediate image, wherein by means of a longitudinal chromatic aberration of the imaging arrangement the object planes are staggered depending on a wavelength of the light from the object along a depth axis. Moreover, an image capturing device is configured to capture the wide-field intermediate image in an imaging manner and in a manner resolved with respect to one or a plurality of selectable spectral components, each corresponding to one of the object planes. “Focus stacking” is then used as a basis to combine a plurality of such wide-field intermediate images for different object planes, an alteration/variation of the focus being achieved by changing/selecting the respective spectral components and thus wavelengths.

### FIELD OF THE INVENTION

The invention lies in the field of metrology and relates in particular to a measuring arrangement, a light microscope and a measuring method for imaging depth measurement.

### BACKGROUND OF THE INVENTION

In an imaging optical system, an object to be imaged or parts thereof is/are usually imaged substantially sharply by the optical system only in a specific distance range. The extent of this distance range is referred to as depth of field. Outside this specific distance range, possible further parts of the object or other objects are imaged in a blurred manner.

In this regard, in the case of a light microscope, for instance, in an object plane parts of an object to be imaged that are situated there are imaged sharply, while further parts of the object or other objects are imaged in a more blurred manner with increasing distance from the object plane. In order that the further parts of the object or other objects can also be imaged sharply, the object or objects can usually be displaced along a depth axis relative to the microscope, such that their distance from the microscope—that is to say from an objective of the microscope, for instance—changes and they are displaced into the object plane. Moreover, it is often possible to set a focussing of the light microscope by displacing optical elements of the light microscope and thus to displace the object plane.

In the case of customary cameras as well—such as photographic cameras or video cameras, for instance—it is possible to set a focussing by displacing optical elements, and thus any distance range in which objects are imaged sharply.

However, this means that in each case only a specific distance range is imaged sharply for each imaging and recording/capture of an imaged object. In order to extend the distance range in which objects are imaged sharply, in the case of depth of field extension—that is to say for instance so-called “focus stacking” or so-called focus variation—a plurality of imagings of the object/objects for different distance ranges imaged sharply in each case—for instance object planes—are captured—for instance by means of variation of the focussing and/or by means of displacement of the object/objects along the depth axis—and from said plurality of imagings in each case those regions are selected which are imaged sharply in each case, and these selected regions are combined to form a joint imaging with a particularly high depth of field.

Capture of an object with a particularly high resolution can additionally be achieved by means of confocal microscopy, in which—in contrast to wide-field microscopy—in each case only a small segment of the object is focussed, illuminated and captured. In this context, in order to determine a two-dimensional or three-dimensional image of the object, a corresponding measurement region is scanned step by step over a multiplicity of such small segments, with the result that an imaging of the object can be reconstructed from the individual segments, without giving rise to a complete image of the object—with possible blurrednesses account of a possible distance from the object plane—during the individual scanning steps.

By way of the dependence of the sharpness of the imaging on the distance between the object and the object plane—that is to say the focal plane, for instance—or correspondingly by way of a reconstructed imaging from a plurality of imagings for different distance ranges or from a multiplicity of segments imaged sharply in each case, it is possible to achieve a depth measurement, that is to say for instance a determination of an absolute or relative distance of an object or a part thereof or else, in the case of capture in an imaging manner, for instance, a—possibly three-dimensional—imaging of the object with full depth of field.

There is a need to improve measuring methods, measuring arrangements and light microscopes for depth measurement and in particular to enable an imaging depth measurement, to reduce a time requirement for a depth measurement, to simplify an implementation of a depth measurement or a measurement set-up, for example a measuring arrangement or a light microscope, for depth measurement and/or to make such an implementation or such a measurement set-up more adaptable.

### SUMMARY OF THE INVENTION

The invention satisfies this need respectively by means of a measuring arrangement for imaging depth measurement, by means of a light microscope and by means of a measuring method for imaging depth measurement in each case in accordance with the teaching of one of the main claims. The dependent claims relate in particular to advantageous embodiments, developments and variants of the present invention.

A measuring arrangement according to claim 1, a light microscope according to claim 8 and a measuring method according to claim 9 are provided. The dependent claims define further embodiments.

A first aspect of the invention relates to a measuring arrangement for imaging depth measurement. The measuring arrangement comprises an imaging arrangement having an objective, and an image capturing device. The imaging arrangement is configured to image light emanating from an object for a plurality of object planes with respect to the object to form a wide-field intermediate image, wherein by means of a longitudinal chromatic aberration of the imaging arrangement the object planes are staggered depending on a wavelength of the light from the object along a depth axis. The image capturing device is configured to capture the wide-field intermediate image in an imaging manner and in a manner resolved with respect to one or a plurality of selectable spectral components—in some variants exactly one spectral component, two spectral components, three spectral components, four spectral components or more than four spectral components simultaneously being selectable—each corresponding to one of the object planes.

One advantage of the longitudinal chromatic aberration in combination with the resolution with respect to the spectral components may reside in particular in the fact that the object planes are staggered, as a result of which it is possible to sharply image different planes of an object—that is to say for instance different heights from the object with respect to the depth axis—by way of the respective spectral components corresponding to the object planes and/or it is possible to increase a distance range along the depth axis in which object planes are imaged at least substantially sharply. One advantage of selecting the respective spectral component and thus a corresponding object plane may reside in particular in the fact that such a selection can be effected more precisely than a mechanical adjustment of a focus of the measuring arrangement or of a light microscope having such a measuring arrangement, thereby enabling a higher resolution with respect to the depth axis. Moreover, such selecting can thus be accelerated, thereby enabling depth measurements to be carried out more efficiently. One advantage of the fact that no mechanical adjustment of the focus is required may also reside in the fact that a set-up of the measuring arrangement is simplified. One advantage of the imaging two-dimensional capture of the wide-field image or of the wide-field intermediate image may reside in particular in the fact that two-dimensional information about the object can be captured with one capturing step, thereby enabling measurements to be carried out more rapidly.

In some embodiments, the imaging arrangement is configured, depending on the wavelength of the light from the object, to sharply image a respective one of the object planes onto the wide-field intermediate image, wherein some or all of the object planes for a respective corresponding wavelength are imaged sharply onto exactly one common wide-field intermediate image. One advantage of imaging the object planes onto a common wide-field intermediate image may reside in particular in the fact that for the—in some variants sharp—capture of the common wide-field intermediate image there is no need for different image planes for different spectral components and/or different object planes, rather it becomes possible to capture the different spectral components of the wide-field intermediate image, each corresponding to an object plane, with respect to exactly one image plane of the common wide-field intermediate image with the image capturing device—possibly in a manner filtered or resolved according to spectral components selected in each case.

In some alternative embodiments relative thereto, the imaging arrangement is configured, for a respective corresponding wavelength, to sharply image a respective one of the object planes onto a respective wide-field intermediate image, wherein the image capturing device is configured to capture the respective wide-field intermediate image for the respective corresponding wavelength—that is to say for instance in a manner resolved with respect to a spectral component comprising the respective wavelength—and in an imaging manner and also sharply—that is to say with a predetermined spatial resolution or a higher spatial resolution. In this case, the longitudinal chromatic aberration of the imaging arrangement can advantageously be combined with possible further chromatic aberrations of the image capturing device in such a way that a resulting wide-field image to be captured is imaged and can be captured sharply.

In some embodiments, the measuring arrangement furthermore comprises an, in particular three-dimensional, measurement region for arranging the object. In this case, in some variants, the object planes lie within the measurement region. In some variants, the object planes extend through the measurement region. In other variants, only some of the object planes, for instance at least one object plane, lie or extend through the measurement region. In some variants, the object is arranged in the measurement region in such a way that at least one of the object planes extends through the object. In this case, in some variants thereof, a multiplicity of the object planes extend through the object or lie at least partly at a surface of the object, while in other variants thereof one or a plurality, in particular a multiplicity, of object planes of the object planes are at a distance from the object with respect to the depth axis—that is to say for instance each lie above or below the object or extend there. One advantage of the multiplicity of object planes which extend through the object or lie there may reside in particular in the fact that it is possible to achieve a higher resolution with respect to the depth axis. One advantage of the multiplicity of object planes which extend at a distance from the object with respect to the depth axis or lie there may reside in particular in the fact that it is possible to extend a distance range with respect to the depth axis within which objects can be captured at least substantially sharply, that is to say, for instance, a focussing of objects is made possible over a larger distance range along the depth axis.

In some embodiments, the measuring arrangement furthermore comprises a light entrance region for illumination light for illuminating the object and/or one or a plurality of light sources configured to generate illumination light for illuminating the object, wherein the illumination light passes from the light entrance region to the object without passing through the image capturing device or parts thereof.

In some embodiments, the image capturing device is embodied as a hyperspectral image capturing device. In some variants, the hyperspectral image capturing device is configured to capture ten or more spectral components simultaneously—that is to say at least substantially at the same time—in a spectrally resolved manner and in a two-dimensionally resolved manner, that is to say for instance as a colour image having ten or more different colours. In some further alternative variants relative thereto, the hyperspectral image capturing device is configured to capture ten or more spectral components in a two-dimensionally resolved manner, wherein the different spectral components are captured in a manner temporally offset with respect to one another.

In some embodiments, the image capturing device comprises an image sensor device, wherein the image sensor device is configured to capture a wide-field image to be captured two-dimensionally and in a manner resolved with respect to a multiplicity of spectral components. In some variants, the image sensor device comprises a multiplicity of groups—for instance at least five or at least eleven groups—of sensor elements arranged in each case in a two-dimensionally distributed manner, wherein each of the groups is sensitive for a specific spectral component of the multiplicity of spectral components. In this advantageous way, it is possible to capture different spectral components, each corresponding to a group of the multiplicity of groups, simultaneously and in a two-dimensionally resolved manner. Furthermore, some variants are configured, in the case of so-called “focus stacking”, to determine in each case those regions for each group of the multiplicity of groups in which the object is imaged sharply for the respective group. Some further variants thereof are furthermore configured to use remaining regions for the respective group, that is to say those which are not imaged sharply in the respective group, for colour information with respect to said remaining regions with respect to the respective spectral component for which the respective group is sensitive.

In some embodiments, the image capturing device comprises an adjustable spectral filter device for selecting said one or said plurality of spectral components. The spectral filter device has an input side and an output side and is configured to transmit a selected spectral component of light coming from the input side to the output side or to reflect it to the output side and correspondingly not to transmit or not to reflect other spectral components. In some variants, the adjustable spectral filter device is configured to filter one or simultaneously a plurality of spectral components and in the process to transmit the latter to the output side or to reflect the latter to the output side, each of which spectral components, depending on respective selecting, lies in a wavelength range of between 200 nm and 4000 nm, between 450 nm and 800 nm, between 400 nm and 900 nm, between 350 nm and 800 nm, between 400 nm and 1500 nm, between 400 nm and 2200 nm or in the visible range, that is to say for instance between 3.8*10̂2 nm and 7.5*10̂2 nm.

In some embodiments, the image capturing device comprises an adjustable Fabry-Perot interferometer for selecting said one or said plurality of spectral components. One advantage of the adjustable Fabry-Perot interferometer may reside in particular in the fact that the latter makes it possible to achieve a large passage region, for instance for a wide-field image/wide-field intermediate image with a large area and/or a large diameter, as a result of which in particular larger two-dimensional regions at the object can be captured simultaneously. Moreover, in this advantageous way, a low energy requirement is achieved and/or it is possible to reduce mechanical wear—for instance by comparison with mechanical exchange of colour filters. In some variants, the adjustable Fabry-Perot interferometer for selecting the spectral component(s) is tunable piezoelectrically or by means of MEMS (Micro-Electro-Mechanical System), thereby enabling particularly rapid and/or exact selection of the respective spectral component or the respective spectral components—possibly in conjunction with a low energy requirement and/or little wear. Moreover, some variants with respect thereto comprise a closed-loop control device with feedback with regard to the selected spectral component(s), thereby enabling for instance a calibration with regard to a position in the spectrum and/or particularly exact setting of the selected spectral component(s). In some other variants, the adjustable Fabry-Perot interferometer is configured to transmit a plurality—for instance two or three—of selected, in particular narrowband, spectral components simultaneously, as a result of which said plurality of spectral components can advantageously be captured simultaneously.

In some further alternative embodiments with respect thereto, the image capturing device comprises a plurality of colour filters as an adjustable spectral filter device, wherein the spectral filter device is configured to guide light from the input side through/onto a respective selected colour filter of the plurality of colour filters.

In some embodiments in which the image capturing device comprises an adjustable Fabry-Perot interferometer—or more generally a spectral filter device—, the image capturing device furthermore comprises an image sensor device. In addition, the measuring arrangement is configured to guide the light from the object, after passing through the imaging arrangement, onto the Fabry-Perot interferometer or the spectral filter device, to filter said light by means of the latter, a narrowband spectral component of the light from the object remaining after the filtering, and to capture the light in an imaging manner by means of the image sensor device. In this case, said narrowband spectral component and thus the spectral components with respect to which the image capturing device effects resolution, and hence the corresponding object planes are selectable by setting the Fabry-Perot interferometer or the spectral filter device. In some variants, exactly one narrowband spectral component of the light from the object remains after the filtering. In some further alternative variants with respect thereto, a plurality—for instance two or three—of respectively narrowband spectral components of the light from the object remain after the filtering.

Within the meaning of the disclosure, a narrowband spectral component should be understood to mean at least one such spectral component whose spectral width is at least small enough that light from the object having wavelengths within this narrowband spectral component is able to be imaged sharply onto the wide-field intermediate image or the wide-field image to be captured by means of the imaging arrangement and possible imaging optics of the image capturing device. In this regard, in the case of such a narrowband spectral component, for instance, its full width at half maximum is less than 60 nm, less than 30 nm, less than 10 nm, less than 5 nm or less than 3 nm. One advantage of a smaller full width at half maximum may reside in particular in the fact that a sharper imaging can be achieved. One advantage of a larger full width at half maximum may reside in particular in the fact that it is possible to increase a light intensity with regard to the light from the object, thereby enabling in particular a shorter exposure time and/or reduced noise. In the case of a plurality of, in particular simultaneously selectable, spectral components, they can be distributed over a spectral range within which a selection is possible—for instance between 200 nm and 4000 nm—, i.e. for instance one of the selected components can be at 4*10̂2 nm, another can be at 6*10̂2 nm and yet another can be at 8*10̂2 nm.

In some embodiments in which the image capturing device comprises an image sensor device and an adjustable Fabry-Perot interferometer—or more generally a spectral filter device, the image sensor device is embodied as a monochromatic image sensor device. The image sensor device as a monochromatic image sensor device is thus configured to capture a wide-field image to be captured two-dimensionally with respect to a light intensity. In this regard, in some variants, the monochromatic image sensor device has only exactly one group of sensor elements arranged two-dimensionally. In some variants, the monochromatic image sensor device is configured to capture the wide-field image to be captured two-dimensionally and at least substantially equally sensitively for at least the selectable spectral components, such that for instance the monochromatic image sensor device outputs a respective sensor value for light of one of the spectral components and for light of another of the spectral components given the same light intensity and these sensor values deviate from one another by at most 20%, at most 10%, or at most 2%. In other alternative variants with respect thereto, a sensitivity of the sensor elements can be different for different spectral components, wherein for instance on account of a preceding filtering—for instance by means of the adjustable Fabry-Perot interferometer—that spectral component which impinges on the sensor elements is known and sensor values of the sensor elements which correspond to a specific light intensity depending on the respective spectral component are thus calibratable. In this advantageous way, it is possible to increase a sensitivity of the image sensor device and/or a spatial resolution capability of the image sensor device.

In some further alternative embodiments with respect thereto in which the image capturing device comprises an image sensor device and an adjustable Fabry-Perot interferometer—or more generally a spectral filter device—, the image sensor device is embodied as a colour image sensor device. The image sensor device as a colour image sensor device is thus configured to simultaneously capture a wide-field image to be captured two-dimensionally and in a manner resolved in terms of colour—for instance as an RGB image, that is to say in a manner resolved according to the colours red, green and blue. In this regard, in some variants, the colour image sensor device has three groups of sensor elements arranged two-dimensionally in each case, wherein for instance one of the groups is sensitive to red, another of the groups is sensitive to green and yet another of the groups is sensitive to blue. Moreover, in some further variants, the colour image sensor device has four groups of sensor elements arranged two-dimensionally in each case, wherein for instance one of the groups is sensitive to red, another of the groups is sensitive to green and yet another of the groups is sensitive to blue, and yet another still of the groups is sensitive to infrared. In this advantageous way it is possible—at least if no spectral component is selected and accordingly no spectral components are filtered out from the wide-field intermediate image or from the light of the object—to capture the object in terms of colour. Different selected spectral components can also be differentiated from one another by means of capturing in terms of colour. In variants in which a plurality of spectral components are selectable simultaneously by means of an adjustable spectral filter device, it is possible to simultaneously capture said spectral components and differentiate them in the process, as a result of which for instance faster scanning of a plurality of object planes is made possible and/or the measuring arrangement can be configured for, in particular faster, autofocussing onto one of the object planes, which corresponds to one of the simultaneously captured spectral components, and/or it becomes possible to determine a distance with respect to the depth axis between two of said object planes—that is to say for instance a height difference—with already an image captured in terms of colour in this way. In this regard, for instance, some variants comprise an adjustable Fabry-Perot interferometer in which in each case two spectral components are selectable simultaneously, and an RGB image sensor device, wherein those colour channels—that is to say for instance groups of sensor elements, for instance pixels—, in which respectively one of the two spectral components is transmitted by the adjustable Fabry-Perot interferometer are determined by means of an intensity analysis and/or contrast analysis of the captured colour image of the object—wherein for instance groups of sensor elements from a colour channel without a selected spectral component at least substantially output a signal which corresponds to darkness, that is to say a very low light intensity—and by means of calibration, for instance, a height difference between the two object planes which correspond to the two selected spectral components is predetermined or is determined and a height difference between those two-dimensional regions of the object which are sharply imaged by one of said two object planes for one of the colour channels and those two-dimensional regions of the object which are sharply imaged by the other of said two object planes for another of the colour channels is thus determined on the basis of the calibration and already the one captured colour image.

In some embodiments in which the image capturing device comprises an image sensor device, the image capturing device furthermore comprises imaging optics. The imaging optics is configured to image the wide-field intermediate image or the selectable spectral component(s) thereof onto an image plane—onto exactly one image plane in some variants—at the image sensor device as a wide-field image to be captured. In addition, the image sensor device is configured to capture said wide-field image to be captured at least two-dimensionally.

In some variants, the image sensor device comprises a group of sensor elements arranged two-dimensionally for the purpose of two-dimensionally capturing the wide-field intermediate image, a wide-field image or light from the object. In some variants thereof, the image sensor device comprises or consists of a CMOS image sensor, wherein for instance the CMOS image sensor comprises a multiplicity of pixels, wherein a respective pixel of the multiplicity of pixels forms a respective sensor element of the sensor elements.

In some embodiments, the image capturing device comprises an image sensor device having an image capturing area, and imaging optics. In this case, the imaging arrangement and the imaging optics form an optical system configured to sharply image a respective one of the object planes onto the image capturing area depending on a wavelength of the light from the object. In addition, the image sensor device is configured to two-dimensionally capture the object plane respectively imaged onto the image capturing area as a wide-field image to be captured. In some variants, the image capturing area of the image sensor device corresponds to the image plane onto which the imaging optics sharply images the wide-field intermediate image or the selectable spectral component(s) thereof.

In some embodiments in which the imaging arrangement and possibly imaging optics form an optical system and the image capturing device has an image capturing area, the depth axis corresponds to an optical axis of the objective and the object planes are at least substantially orthogonal to the depth axis—such that for instance the object planes each form an angle of between 40° and 130°, an angle of between 80° and 100°, an angle of between 85° and 95° or an angle of between 89° and 91° with the depth axis and are possibly spaced apart from one another at a predetermined distance from one another along the depth axis, said distance being dependent on a difference between the respectively corresponding wavelengths. In this case, the optical system has a depth of field which defines a distance range from a respective one of the object planes along the depth axis. In addition, the optical system is configured, within said distance range, to image the object at least substantially sharply onto the image capturing area for that wavelength of the light from the object which corresponds to the respective object plane.

Within the meaning of the disclosure, a wide-field image should be understood to mean at least one image of an object which—for instance in contrast to confocal microscopy—contains two-dimensional information of the object and corresponds for instance to a two-dimensional region of the object or to the entire object. Accordingly, within the meaning of the disclosure, wide-field microscopy should be understood at least to mean that an object's entire region to be imaged is imaged simultaneously—as in the case of traditional light microscopy, for instance. This is to be delimited from methods and devices in which the region to be imaged is scanned successively—as in the case of confocal microscopy, for instance.

Within the meaning of the disclosure, a wide-field intermediate image should be understood to mean at least one intermediate image in an optical system which contains two-dimensional information of the object. In this case, for instance, the wide-field intermediate image in an image plane of the wide-field intermediate image can be a sharp imaging of the object or of at least one finite two-dimensional region thereof. In so far as light from the object has different spectral components, for instance, the wide-field intermediate image can also have corresponding spectral components, wherein in some variants the wide-field intermediate image is sharp at least for one spectral component of the spectral components and with respect to a corresponding object plane, while other spectral components—for instance on account of a chromatic aberration—may be blurred in the case of this object plane and/or the wide-field intermediate image may be blurred for this spectral component with respect to other object planes—for instance on account of a limited depth of field.

Within the meaning of the disclosure, a sharp imaging should be understood to mean at least such an imaging which images a (light) point onto a two-dimensional region—for instance in an image plane or on an image capturing area—having at most a predetermined size, that is to say for instance at most a predetermined extent. In this case, the size or extent of the two-dimensional region—that is to say for instance the area thereof or the diameter thereof—may be dependent on a desired spatial resolution. In an optical system, for instance, only those points which lie in an object plane of the optical system are imaged, in particular in absolute terms, sharply within the scope of the diffraction limit, while other points are imaged less sharply with increasing distance from the object plane. In this case, optical systems can have a depth of field which defines a distance range from the object plane within which points which lie there are imaged at least substantially sharply, such that a desired spatial resolution can be achieved within this distance range, for instance.

In this respect, see:
“Schärfentiefe” [“Depth of field”] in the version of Nov. 1, 2019 at Wikipedia.de:
   https://de.wikipedia.org/w/index.php?title=Sch%C3%A4rfentiefe&oldid=193646047
“Focus Stacking” in the version of Nov. 1, 2019 at Wikipedia.de:
   https://de.wikipedia.org/w/index.php?title=Focus_stacking&oldid=193649887
“Fokusvariation” [“Focus variation”] in the version of Jul. 7, 2018 at Wikipedia.de:
   https://de.wikipedia.org/w/index.php?title=Fokusvariation&oldid=178947710
   and
“Konfokalmikroskop” [“Confocal microscope”] in the version of Dec. 2, 2019 at Wikipedia.de:
   https://de.wikipedia.org/w/index.php?title=Konfokalmikroskop&oldid=194581743
   In this case, in the confocal microscope, a pinhole stop is closed in such a way that no wide-field image or wide-field intermediate image arises.

In some embodiments, each object plane of the object planes is assigned a respective wavelength of the light from the object from a respective selected spectral component at which regions of the object which lie in the respective object plane—that is to say lie for instance at a height of the respective object plane with respect to a distance along the depth axis—are imaged sharply, in particular absolutely sharply, onto the wide-field intermediate image and/or wide-field image.

In some embodiments, the imaging arrangement has a longitudinal chromatic aberration such that for a wavelength range of the light from the object of 400 nm to 800 nm the object planes are arranged along the depth axis over at least 300 μm or 5 μm. In this case, in some variants, a first object plane of the object planes, which corresponds to the selectable spectral component having the shortest wavelength, is spaced apart from a last object plane of the object planes, which corresponds to the selectable spectral component having the longest wavelength, by at least 300 μm or at least 5 μm. In some variants thereof, a distance between the first and last object planes—that is to say for instance a height difference between the latter—is within a range of between 4 mm and 10 μm.

In some embodiments, the longitudinal chromatic aberration and the full width at half maximum of the respectively selectable spectral components are coordinated with one another in such a way that light from a respective selected spectral component corresponds only to a distance range along the depth axis from the respectively sharply imaged object plane which is smaller than the depth of field. In some variants, the ratio of this distance range to the depth of field is less than or equal to ½ or less than or equal to ⅓. In this advantageous way, for a respectively selected spectral component, the wide-field image and possibly the wide-field intermediate image are imaged at least substantially sharply.

In some embodiments, the longitudinal chromatic aberration and the depth of field are coordinated with one another in such a way that over an entire spectral range within which the spectral components are selectable, all corresponding object planes are spaced apart from one another at most by a distance corresponding to the depth of field, to one third of the depth of field or to one quarter of the depth of field. In this advantageous way, for a respectively selected spectral component, the wide-field image and possibly the wide-field intermediate image are imaged particularly sharply and/or all object planes—for a corresponding spectral component—are imaged sharply, as a result of which it is possible to achieve in particular a high resolution along the depth axis. In this regard, in some variants, an adjustable spectral filter device of the image capturing device in interaction with the longitudinal chromatic aberration is configured to filter the light from the object in such a way that a—respectively selectable—narrowband spectral component of the light from the object remains after filtering by means of the adjustable spectral filter device, wherein those object planes which correspond to a respective wavelength of the light from the object within a wavelength range over a full width at half maximum of the respective narrowband spectral component are spaced apart from one another by at most 120 nm, at most 9 nm or at most 2 nm. In this advantageous way, it is possible to resolve height differences with a correspondingly high resolution along the depth axis—that is to say for instance already to differentiate a height difference of 120 nm, 9 nm or 2 nm. In this regard, in some variants, the objective has a numerical aberration of approximately or exactly 1.4 and a depth of field of approximately or exactly 250 nm—for example at a wavelength of approximately or exactly 500 nm—, the longitudinal chromatic aberration over a wavelength range of 400 nm to 800 nm brings about a maximum distance of the object planes along the depth axis of approximately or exactly 100 nm and the full width at half maximum for the selectable spectral components is approximately or exactly 5 nm, thus resulting, if the wavelength range of 400 nm to 800 nm is scanned in steps of the full width at half maximum—that is to say in each case 5 nm, for instance—, in 80 steps with captured images of the object for correspondingly 80 different object planes which are staggered along a distance range of approximately or exactly 100 nm. Consequently, it is possible for instance to resolve distances between the object planes—for instance between object planes adjoining one another—which are approximately 100 nm/80, that is to say approximately 1 nm, and/or to image the object planes sharply, in particular absolutely sharply.

In some alternative embodiments with respect thereto, the longitudinal chromatic aberration and the depth of field are coordinated with one another in such a way that over an entire spectral range within which the spectral components are selectable, all corresponding object planes are at least spaced apart from one another by a distance corresponding to ⅔ of the depth of field, to seven times the depth of field or to 60 times the depth of field. In this advantageous way, it is possible to achieve a large measurement region with respect to the depth axis and thus, for instance, for different spectral components selected over the entire spectral range, to enable scanning along the depth axis over a larger distance range—that is to say for instance over a larger height difference—, as a result of which in particular an extended depth of field can be achieved. In some variants, the measuring arrangement comprises an autofocussing device configured to determine as the focussed object plane that one of the object planes for which light from the object with a corresponding spectral component is imaged at least substantially sharply. In this case, one advantage of a larger distance range made possible may reside in particular in the fact that the autofocussing device enables an autofocussing within this larger distance range—that is to say for instance over a range of at least 1 mm, 4 mm or 1 cm—by selection of a corresponding spectral component. In some alternative variants with respect thereto, the distance range made possible is smaller than the larger distance range made possible—for instance smaller than 1 mm. In some variants, an adjustable spectral filter device of the image capturing device in interaction with the longitudinal chromatic aberration is configured to filter the light from the object in such a way that a—respectively selectable—narrowband spectral component of the light from the object remains after filtering by means of the adjustable spectral filter device, wherein those object planes which correspond to a wavelength of the light from the object within a wavelength range over a full width at half maximum of the respective narrowband spectral component are spaced apart from one another by at most 120 nm, at most 9 nm or at most 2 nm. In some variants thereof, the depth of field is small enough that only a small number of respectively adjacent object planes of the object planes, in particular only three object planes or only one respective object plane, are imaged at least substantially sharply. In this case, in some variants, the small number of respectively adjacent object planes, in particular the in each case only exactly one sharply imaged object plane, is differentiated from the other object planes on the basis of a sharpness of the imaging—determined by means of contrast analysis, for instance. In this advantageous way, it is possible to resolve height differences with a correspondingly high resolution along the depth axis—that is to say for instance already to differentiate object planes with a height difference of 120 nm, 9 nm or 2 nm.

In some embodiments, the imaging arrangement furthermore comprises an adjustable aberration device, by means of which the longitudinal chromatic aberration of the imaging arrangement is adjustable. In this advantageous way, it is possible to set the dependence between the object planes and the respective wavelengths—that is to say for instance spectral components having a respective wavelength. In this regard, for instance, with a large longitudinal chromatic aberration for two predefined, specific wavelengths of the light from the object, it is possible to achieve a larger distance between the corresponding object planes by comparison with a smaller longitudinal chromatic aberration, as a result of which for instance it is possible to enlarge a measurement region, over which the object planes are distributed, in the direction of the depth axis. Conversely, with a smaller longitudinal chromatic aberration, it is possible to increase a spatial resolution capability along the depth axis.

In some embodiments in which the imaging arrangement comprises an adjustable aberration device, the adjustable aberration device comprises a mount for a respective aberration element of a plurality of aberration elements. In this case, the mount is configured to hold the respective aberration element in a releasable manner. In addition, the adjustable aberration device is configured to guide the light from the object, after passing through the objective, to the aberration element and to refract it by means of the respective aberration element in such a way that in interaction with the objective the longitudinal chromatic aberration occurs and the object planes are staggered along the depth axis depending on the wavelength of the light from the object.

In some embodiments in which the imaging arrangement comprises an adjustable aberration device, the adjustable aberration device comprises at least two optical elements, the distance between which is adjustable in such a way that the longitudinal chromatic aberration is dependent on the distance respectively set.

In some embodiments, the objective has a longitudinal chromatic aberration such that for a wavelength range of the light from the object of 400 nm to 800 nm the object planes are arranged along the depth axis over at least 300 μm or 10 μm or 5 μm. In this case, in some variants, a first object plane of the object planes, which corresponds to the selectable spectral component having the shortest wavelength, is spaced apart from a last object plane of the object planes, which corresponds to the selectable spectral component having the longest wavelength, by at least 300 μm, at least 100 μm or at least 5 μm. In some variants thereof, a distance between the first and last object planes—that is to say for instance a height difference between these object planes—is within a range of between 1.4 mm and 0.5*10̂1 μm.

In some further alternative embodiments with respect thereto, the objective is an achromatic objective and the imaging arrangement furthermore comprises an aberration device, which brings about the longitudinal chromatic aberration of the imaging arrangement. In this case, in some variants, the aberration device is configured to bring about a longitudinal chromatic aberration such that, for a wavelength range of the light from the object of 400 nm to 800 nm, the object planes are arranged along the depth axis over at least 300 μm or over at least 10 μm or over at least 1 μm. In this case, in some variants, a first object plane of the object planes, which corresponds to the selectable spectral component having the shortest wavelength, is spaced apart from a last object plane of the object planes, which corresponds to the selectable spectral component having the longest wavelength, by at least 300 μm, at least 10 μm or at least 1 μm. In some variants thereof, a distance between the first and last object planes—that is to say for instance a height difference between these object planes—is within a range of between 4 mm and 1 μm, that is to say for instance within a range of between 4 mm and 1 mm or within a range of between 3 mm and 1.4 mm or within a range of between 5*10̂2 μm and 1 μm or within a range of between 50 μm and 5 μm.

A second aspect of the invention relates to a light microscope for imaging depth measurement, wherein the light microscope comprises a measuring arrangement in accordance with the first aspect of the invention, that is to say correspondingly comprises at least one imaging arrangement and an image capturing device. The imaging arrangement can comprise an objective mount for an objective. The imaging arrangement is configured to image light emanating from an object for a plurality of object planes with respect to the object to form a wide-field intermediate image, wherein by means of a longitudinal chromatic aberration of the imaging arrangement the object planes are staggered depending on a wavelength of the light from the object along a depth axis. The image capturing device is configured to capture the wide-field intermediate image in an imaging manner and in a manner resolved with respect to one or a plurality of selectable spectral components, each corresponding to one of the object planes.

The possible advantages, embodiments or variants of the first aspect of the invention are correspondingly applicable to the light microscope as well. In this case, for instance, parts of the light microscope, such as, for instance, the imaging arrangement or the image capturing device, can be embodied in accordance with the first aspect of the invention and/or for instance form a measuring arrangement in accordance with the first aspect of the invention.

In some embodiments, the light microscope comprises a light source and a beam splitter. In this case, the light microscope is configured to generate the illumination light by means of the light source and to guide the illumination light to the beam splitter and further, after passage through the latter and without passage through the image capturing device or parts thereof, to the imaging arrangement. Furthermore, the imaging arrangement is configured to guide said illumination light onto the object.

One advantage of the fact that illumination light is guided to the object without passing through the image capturing device or parts thereof may reside in particular in the fact that different types of illumination are made possible. In this regard, for instance, structured illumination and/or confocal illumination might not be required. Moreover, illumination with external light sources or with polychromatic light sources or with white light sources is made possible, provided that light from these light sources has spectral components corresponding to the object planes or brings about emission of such light from the object—for instance on account of fluorescence.

In some embodiments, the light microscope is configured for illuminating the object by means of bright-field illumination and/or dark-field illumination.

In some embodiments, the light microscope is configurable for illuminating the object by means of polychromatic and/or narrowband, for instance monochromatic, illumination.

In some embodiments, the light microscope is configured for illuminating the object by means of coaxial illumination.

A third aspect of the invention relates to a measuring method for imaging depth measurement. The measuring method comprises imaging light emanating from an object for a plurality of object planes with respect to the object to form a wide-field intermediate image. In this case, the object planes are staggered depending on a wavelength of the light from the object along a depth axis by means of a longitudinal chromatic aberration. Furthermore, the measuring method comprises capturing the wide-field intermediate image in an imaging manner, wherein one or a plurality of selectable spectral components of the light from the object, each corresponding to one of the object planes, are resolved.

The possible advantages, embodiments or variants of the previous aspects of the invention are correspondingly applicable to the measuring method as well. Moreover, for instance, the measuring arrangement in accordance with the first aspect of the invention or the light microscope in accordance with the second aspect of the invention can be configured to carry out a method in accordance with the third aspect of the invention.

In some embodiments, a measurement region is illuminated.

In some embodiments, the object is arranged within a measurement region or within the illuminated measurement region.

In some embodiments, the object planes extend through the measurement region or lie within the measurement region.

In some embodiments, one or a plurality of object planes extend through the object.

In some embodiments, the object is focused. In some variants, at least one of the object planes is focused, which extends through the object.

In some embodiments, a plurality of the object planes are scanned, wherein a respective one of the object planes is selected and those spectral components of the wide-field intermediate image which correspond to the respectively selected object plane are captured in an imaging manner.

In some embodiments, the dependence between the object planes and the respective wavelengths of the light from the object is calibrated by means of a calibration object.

Some embodiments involve calculating those two-dimensional regions in the wide-field intermediate image respectively captured for a respective wavelength and object plane at which the respective object plane is imaged sharply.

In some embodiments, a topography of the object is determined on the basis of the calculated two-dimensional regions and the respective object planes.

Some embodiments involve determining a joint imaging of the object—for instance with an extended depth of field—on the basis of the captured wide-field intermediate images and their respective two-dimensional regions. In some variants the joint imaging is calculated by means of combining those segments of the captured wide-field intermediate images which correspond to the respective two-dimensional regions for which the respective object plane is imaged sharply. Some of such variants are implemented as focus stacking, wherein the alteration/variation of the focus is achieved by changing/selecting the respective spectral components and thus wavelengths.

A further aspect of the invention relates to a system comprising a measuring arrangement in accordance with the first aspect of the invention or a light microscope in accordance with the second aspect of the invention and comprising a calibration object for calibrating the dependence between the object planes and the respective wavelengths. In this case, in some variants, the calibration object can have a specific stepped structure. Moreover, in some variants, the calibration object can be colourless, for instance grey or white. Alternatively, in some variants, the calibration object can be coloured, wherein for instance specific regions of a stepped structure of the calibration object each have a specific colour in such a way that light having a wavelength, which light corresponds to an object plane to be calibrated, is emitted by the calibration object at the respective stepped structure.

The possible advantages, embodiments or variants of the previous aspects of the invention are correspondingly applicable to the system comprising the calibration object as well.

Further advantages, features and application possibilities are evident from the following detailed description of exemplary embodiments and/or from the figures.

The invention is explained in greater detail below on the basis of advantageous exemplary embodiments with reference to the figures. Identical elements or component parts of the exemplary embodiments are identified substantially by identical reference signs, unless something to the contrary is described or unless something to the contrary is evident from the context.

### BRIEF DESCRIPTION OF THE DRAWINGS

In this respect, in the figures, partly schematically:

FIG. 1 shows a measuring arrangement according to one embodiment with a calibration object according to one embodiment;

FIG. 2 shows a light microscope according to one embodiment;

FIG. 3 shows a plurality of imagings of an object for different object planes and also a height profile of the object and an assignment to the different object planes for elucidating one embodiment;

FIG. 4 shows a flow diagram of a measuring method according to one embodiment;

FIG. 5 shows a plurality of different object planes and also one region along a depth axis with respect to a depth of field for elucidating embodiments;

FIG. 6 shows a plurality of different object planes and also a plurality of regions along a depth axis with respect to a depth of field for elucidating embodiments; and

FIG. 7 shows a flow diagram of a measuring method according to a further embodiment.

### DETAILED DESCRIPTION OF THE INVENTION

The figures are schematic illustrations of various embodiments and/or exemplary embodiments of the present invention. Elements and/or component parts illustrated in the figures are not necessarily illustrated as true to scale. Rather, the various elements and/or component parts illustrated in the figures are rendered in such a way that their function and/or their purpose become comprehensible to the person skilled in the art.

Connections and couplings between the functional units and elements as illustrated in the figures can also be implemented as indirect connections or couplings. In particular, data connections can be embodied as wired or wireless, that is to say in particular as radio connections. Moreover, certain connections, for instance electrical connections, for instance for supplying energy, may not be illustrated for the sake of clarity. Furthermore, optical connections—for instance between optical elements—, which may be illustrated in particular as a straight light ray, can also be implemented, in some variants, by means of an optical waveguide and/or by optical elements, such as mirrors, for deflecting light rays, such connections not necessarily being illustrated for the sake of clarity.

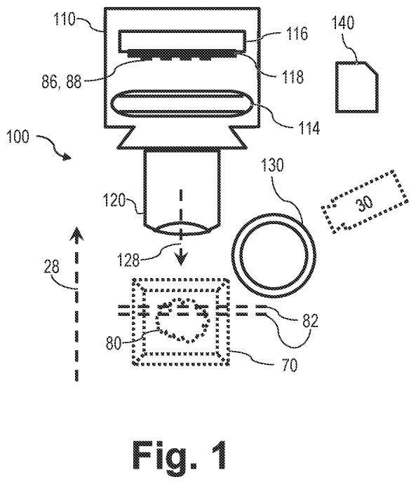

FIG. 1 schematically shows a measuring arrangement 100 according to one embodiment of the present invention. FIG. 1 additionally illustrates an illumination device 30, a calibration object 70, an object 80 and a control device 140. In this case, in some variants, the measuring arrangement 100 comprises the illumination device 30 or the control device 140. Moreover, a system according to one embodiment of the present invention can comprise the measuring arrangement 100 and the calibration object 70 and possibly the illumination device 30, the object 80 and/or the control device 140.

In one exemplary embodiment, the measuring arrangement 100 comprises an image capturing device 110 and, as an imaging arrangement, an objective 120—in this regard, for instance, the imaging arrangement can consist of the objective 120. The image capturing device 110 comprises an adjustable Fabry-Perot interferometer 114 as an adjustable spectral filter device and a CMOS image sensor 116 as an image sensor device, wherein the CMOS image sensor 116 comprises a two-dimensional matrix with pixels—for instance monochromatic pixels—that form an image capturing area 118. In this case, the CMOS image sensor 116 is configured, by means of the pixels, to capture an image imaged on the image capturing area 118—for instance a wide-field image or a wide-field intermediate image—in a two-dimensionally resolved manner and possibly monochromatically. The adjustable Fabry-Perot interferometer 114 is configured for selecting a plurality of spectral components of light, wherein the Fabry-Perot interferometer 114 transmits in each case only light having wavelengths within a respectively selected spectral component from the objective 120 to the image sensor device, that is to say to the image capturing area 118, for instance, and reflects or absorbs other spectral components. In some variants, the Fabry-Perot interferometer 114 is tunable piezoelectrically, thereby enabling particularly rapid and/or exact selection of the respective spectral component.

For imaging depth measurement, it is possible to arrange the object 80 at the objective 120 in such a way that said object is arranged at the objective 120 in a region through which an optical axis 128 of the objective 120 extends. Moreover, it is possible to arrange the object 80 at the calibration object 70 in order to enable for instance a calibration during the imaging depth measurement. In some variants, for this purpose, the calibration object 70 has a receiving region for an object to be measured, that is to say the object 80, for instance, within which region the object can be arranged. In this advantageous way, during the calibration determined object planes—that is to say heights of a topography, for instance—can be assigned directly to determined object planes at the object since both can be simultaneously captured and determined in some variants.

Moreover, in some variants, the measuring arrangement 100 comprises a light entrance region 130 for illumination light for illuminating the object 80. In some variants, the light entrance region 130 extends around—at least substantially—the entire region around the objective 120 and the object 80—in this regard, for instance, the object 80 can lie at an open region which is accessible to ambient light—for instance on a conveyor belt or possibly on a calibration object on the conveyor belt—, from which the objective 120 images the object 80.

Moreover, in some variants, the measuring arrangement 100 comprises the illumination device 30, while in some further alternative variants with respect thereto, the illumination device 30 is external and is configured to illuminate the object 80—possibly through the light entrance region 130.

In this case—as illustrated in FIG. 1, for instance—the illumination light can pass from the light entrance region 130 and/or from the illumination device 30 to the object 80 without passing through the image capturing device 110 or parts thereof—for instance the Fabry-Perot interferometer 114.

The objective 120 is configured to image light emanating from the object 80—for instance on account of illumination with illumination light and/or on account of a self-luminous property of the object such as fluorescence or conversion of some other form of energy into light—for a plurality of object planes 82 with respect to the object to form a wide-field intermediate image 86. In this case, the object planes 82 are staggered depending on a wavelength of the light from the object along a depth axis 28 on account of a longitudinal chromatic aberration of the objective 120. In this regard, for instance, object planes corresponding to a longer wavelength, with respect to the depth axis 28, can be further away from the objective 120 than other object planes, corresponding to a shorter wavelength—or vice versa. In this case, in some variants, the depth axis 28 corresponds to the axis 128 of the objective and extends in the same direction or—as illustrated in FIG. 1—in the opposite direction, the object planes 82 being at least substantially orthogonal to the depth axis 28.

The objective 120 together with the Fabry-Perot interferometer 114 forms an optical system configured to sharply image light from the object having wavelengths that lie in a respectively selected spectral component from a respective corresponding one of the object planes 82 onto exactly one common image plane as a wide-field image 88 to be captured onto the image capturing area 118. In this case, for instance—as illustrated in FIG. 1—the wide-field intermediate image 86 and the wide-field image 88 can coincide—that is to say can be identical to one another, for instance—and the image plane can extend along the image capturing area 118, for instance. Consequently, for instance, on the basis of selecting the respective spectral component, it is possible to select in each case a selected object plane of the object planes 82 which is sharply imaged and captured two-dimensionally by means of the CMOS image sensor 116, while other spectral components of the light from the object—that is to say correspondingly also from the wide-field intermediate image 86—, for which the respective object plane would not be imaged sharply, are filtered out by means of the Fabry-Perot interferometer 114. Accordingly, the optical system has a depth of field and is configured, within a distance range around a respectively selected object plane, to image the object for the wavelength corresponding to the selected object plane—that is to say for wavelengths in the respectively selected spectral component—at least substantially sharply onto the image capturing area 118. In this case, it goes without saying that a sharpness of the imaging decreases with increasing distance from the respectively selected object plane, wherein, for instance, at least substantially sharp imaging is effected at least if a light spot imaged in this way extends at most over a specific region at the image capturing area. In this case, the size of the specific region—that is to say for instance the area or the diameter of the region—may be dependent on a desired spatial resolution. In this regard, for instance, the size of the specific region may correspond to nine pixels, four pixels or one pixel of the CMOS image sensor 116, wherein, for instance, the pixels adjoin one another—for instance 3×3 pixels or 2×2 pixels.

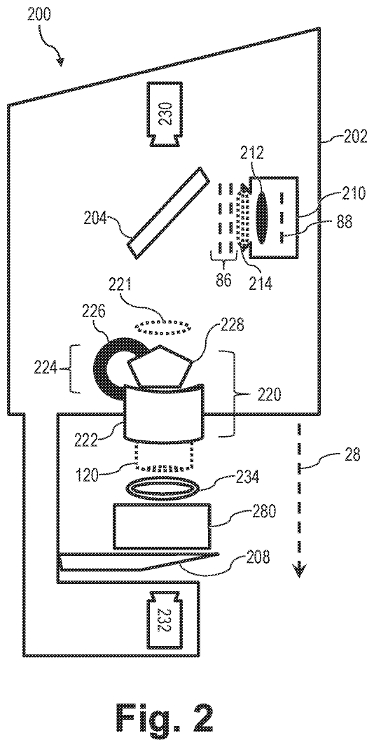

FIG. 2 schematically shows a light microscope 200 according to one embodiment of the present invention.

In one exemplary embodiment, the microscope 200 comprises an image capturing device 210 and an imaging arrangement 220 and also a beam splitter 204, a first illumination device 230 and a second illumination device 232, which are arranged in a housing 202 of the microscope 200. In addition, the microscope 200 comprises an object stage 208, by means of which an object can be arranged in a measurement region 280 of the microscope 200. In some variants, the microscope comprises a third illumination device 234, embodied as a ring luminaire, for instance.

The first illumination device 230 is configured to generate light, to emit light onto the beam splitter 204 and to illuminate the measurement region 280 with the light after passage through the beam splitter 204 and through the imaging arrangement 220 and a possible objective—for instance for reflected light illumination.

The second illumination device 232 is configured to generate light and to emit light through the object stage 208 to the measurement region 280—for instance for transmitted light illumination. In this case, in some variants, the illumination device 232 is configured for dark-field illumination.

The image capturing device 210 comprises imaging optics 212 and, in some variants, is furthermore embodied according to the image capturing device 110 from FIG. 1. In some alternative variants with respect thereto, the image capturing device 210 comprises an image sensor device configured to capture a wide-field image two-dimensionally and in a manner resolved according to a plurality of spectral components—for instance by means of a multiplicity of groups of pixels arranged two-dimensionally, which are each sensitive for a specific one of the plurality of spectral components. For this purpose, in some variants thereof, the image capturing device 210 comprises an RGB camera. Conversely, some modifications of the image capturing device 110 with respect to FIG. 1 can also comprise a colour image sensor device, for instance an RGB camera.

The imaging arrangement 220 comprises an adjustable aberration device 224, by means of which a longitudinal chromatic aberration of the imaging arrangement 220 is adjustable.

In addition, the imaging arrangement 220 comprises an objective mount 222 for an objective 120. In this case, the objective 120 is not necessarily part of the light microscope 200. In this regard, in some variants, for instance, the objective mount 222 is configured to hold various objectives and to be connected releasably to a respective one of the various objectives in such a way that light emanating from the object when it is arranged in the measurement region 280 is guided through the respective objective to the adjustable aberration device 224. In this way, it is possible to use various objectives and it is thus possible to achieve, for instance, different magnifications, measurement regions and/or working distances at which an object to be captured is to be arranged with respect to the depth axis or axis of the objective.

The adjustable aberration device 224 comprises an aberration element 228 and a mount 226 for the aberration element 228, wherein the mount 226 is configured to be releasably connected to the aberration element 228 or to a respective one of a plurality of further aberration elements in such a way that light coming from the objective or from the objective mount 222 is guided through the respective aberration element to the beam splitter 204.

The imaging arrangement 220 is configured to guide light emanating from the object for a plurality of object planes in the measurement region 280, which are staggered along a depth axis 28, to the aberration element by means of the objective, wherein the aberration element 228 in interaction with the objective brings about a longitudinal chromatic aberration such that each of the object planes for a specific wavelength of the light that corresponds to this object plane—for instance after reflections at the beam splitter 204—is imaged sharply to form exactly one common wide-field intermediate image 86. The common wide-field intermediate image 86 thus has a plurality of spectral components corresponding respectively to one of the object planes.

Furthermore, the imaging optics 212 is configured to image said common wide-field intermediate image 86 onto exactly one common wide-field image 88, wherein the image capturing device 210 is configured to capture this common wide-field image 88 two-dimensionally.

In some alternative variants with respect thereto, the object planes are firstly imaged to form different wide-field intermediate images 86—as illustrated in FIG. 2—, wherein the imaging optics 212 has a chromatic aberration such that said different wide-field intermediate images 86 or respectively corresponding spectral components of a respective wide-field intermediate image are imaged sharply to form exactly one common wide-field image 88.

In some variants, the image capturing device 210 is configured to capture the common wide-field image 88 in a manner resolved according to the spectral components thereof and two-dimensionally, for instance by means of a multiplicity of groups of pixels arranged two-dimensionally. In some alternative variants with respect thereto, the image capturing device 210 is configured to filter the common wide-field intermediate image 86 in each case with respect to a selected spectral component—for instance by means of an adjustable Fabry-Perot interferometer 214—, the wide-field image 88 having in each case only this spectral component, and to capture it two-dimensionally. In some alternative variants with respect thereto, the image capturing device 210 is configured to filter out from the different wide-field intermediate images 86 in each case one with a selected spectral component, to image it to form the common wide-field image 88 by means of the imaging optics 212—that is to say to image the respective wide-field intermediate image 86 onto a common image plane for the wide-field image 88—and to capture the latter—i.e. in other words the spectral component selected respectively, for instance by means of an adjustable Fabry-Perot interferometer 214—two-dimensionally.

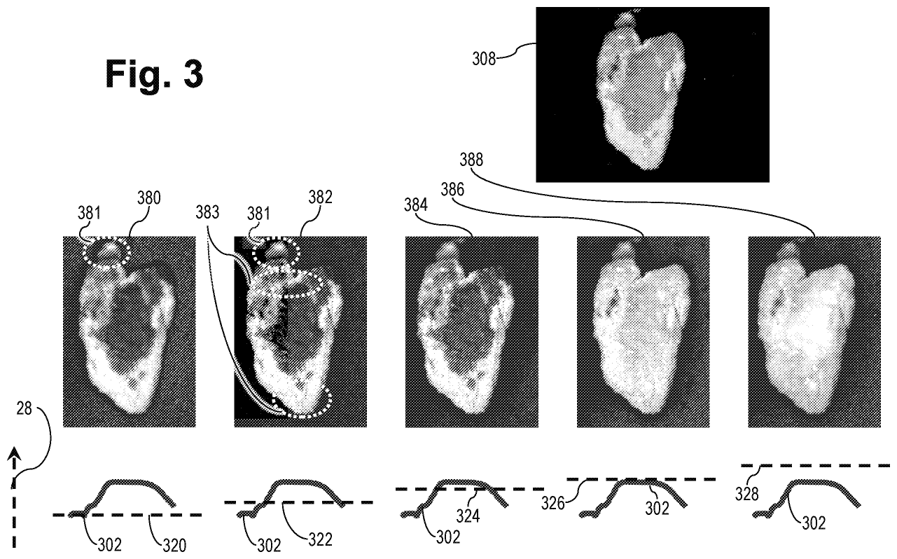

FIG. 3 illustrates one embodiment and/or application of the present invention on the basis of a plurality of imagings of an object for different object planes, a height profile of the object and an assignment to the different object planes.

In one exemplary embodiment, the object corresponds to the object imaged by imaging 308 and has a height profile 302. The further imagings 380, 382, 384, 386 and 388 show the object for different object planes. The object planes are staggered along a depth axis 28. In this regard, in imaging 380, the object plane 320 arranged bottommost with respect to the depth axis 28 is imaged at least substantially—i.e. for instance within the scope of a depth of field—sharply.

Accordingly, the object plane 322 is imaged sharply in imaging 382, the object plane 324 is imaged sharply in imaging 384 and the object plane 326 is imaged sharply in imaging 386. Imaging 380 was captured for a spectral component at a wavelength of 450 nm. Imaging 382 was captured for a spectral component at a wavelength of 550 nm. Imaging 384 was captured for a spectral component at a wavelength of 650 nm. Imaging 386 was captured for a spectral component at a wavelength of 700 nm. Imaging 388 was captured for a spectral component at a wavelength of 800 nm. In this case, the object planes 320 to 328 are staggered over a distance range along the depth axis 28, pointing out of FIG. 3 for the imagings, of approximately 1 mm, i.e. in other words the object plane 320 is spaced apart from the object plane 328 by approximately 1 mm. Furthermore, the spacings were not calibrated and may be linear or nonlinear with regard to a dependence between distance and wavelength.

It is additionally clear from FIG. 3 that the object plane 328 arranged topmost with respect to the depth axis 28 lies above the height profile 302 and, consequently, in imaging 388, no region of the object is imaged sharply since the object plane 328 extends through no region of the object.

In the other imagings 380, 382, 384 and 386 for a respective one of the object planes 320, 322, 324 and 326, in each case specific regions of the object are imaged sharply. In this regard, for instance, in imaging 380, the region 381 through which the object plane 320 extends is imaged sharply, while said region is not imaged sharply in imaging 382. By contrast, in imaging 382, the regions 383 through which the object plane 322 extends are imaged sharply. The imagings 380, 382, 384 and 386 thus form a so-called z-stack—that is to say for instance a stack of imagings along the depth axis, wherein each of the imagings for a specific volume region, which extends along the depth axis around a respectively corresponding object plane and is governed by the depth of field, those regions of the object which lie in the respective volume region, is imaged at least substantially sharply—, in which the object planes are staggered along the depth axis 28 by means of the longitudinal chromatic aberration, and said imagings can be combined to form a joint imaging with an extended depth of field by means of a method with so-called focus stacking, wherein in each case those regions of a respective imaging which are imaged sharply in the respective imaging are selected for the combining, which can be determined by means of a contrast analysis, for instance.

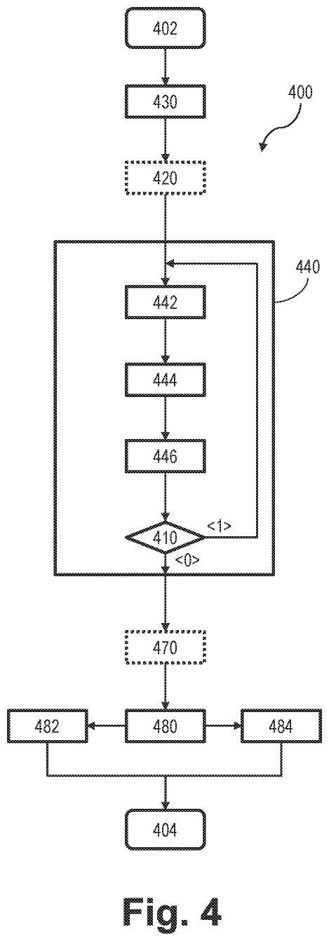

FIG. 4 shows a flow diagram of a measuring method 400 according to one embodiment of the present invention.

In one exemplary embodiment, the method 400 comprises the method steps 430, 440, 442, 444, 446, 480, 482 and 484 and also the method condition 410. The measuring method 400 begins at the method start 402 and ends at the method end 404.

In the method step 430, a measurement region is illuminated with illumination light, for instance polychromatic light, for instance white light with a plurality of spectral components.

In some variants, in a method step 420 of the measuring method 400, an object is arranged within the measurement region and an object plane which extends through the object is focused. In this case, in some variants, the object plane is focused for at least one of the spectral components of the illumination light.

In the method step 440, a plurality of object planes are scanned. For this purpose, the method step 440 comprises the method steps 442, 444 and 446 and also the method condition 410.

In the method step 442, light emanating from the object is imaged to form a wide-field intermediate image, wherein by means of a longitudinal chromatic aberration a selected object plane of the object planes is imaged sharply for a selected spectral component of the spectral components.

In the method step 444, from the wide-field intermediate image the selected spectral component is filtered—for instance by means of an adjustable interferometer.

In the method step 446, this filtered spectral component of the wide-field intermediate image is captured in an imaging manner two-dimensionally—for instance by means of an image sensor device.

The method condition 410 involves checking whether a further object plane of the object planes is to be selected. If this is the case—symbolized by <1>—, the method is continued at method step 442, wherein the further object plane is the selected object plane, and a further spectral component corresponding to this further selected object plane is filtered in the method step 444. In this regard, for instance, in some variants, the adjustable interferometer is correspondingly set to this further selected spectral component. If no further object plane is to be selected—symbolized by <0>—, the method is continued at method step 470 or at method step 480.

In some variants, in a method step 470 of the measuring method 400, a dependence between the object planes and the respective spectral components for a calibration is determined by means of a calibration object. For this purpose, in some variants, the method step 440 is carried out for the calibration object and calibration data are determined on the basis of a known topography of the calibration object and the respectively selected spectral components.

The method step 480 involves calculating those two-dimensional regions in the wide-field intermediate image respectively captured for a respective spectral component and object plane at which a respective object plane is imaged sharply. In some variants thereof, for this purpose, a contrast analysis is carried out, wherein the wide-field intermediate images are subdivided into two-dimensional segments and for each of these two-dimensional segments in each case the wide-field intermediate image is selected which exhibits the greatest contrast in the respective segment for the respectively selected wide-field intermediate image, whereby the sharply imaged regions of the respective wide-field intermediate image correspond to the segments for which the respective wide-field intermediate image has been selected.

In the method step 482, a topography of the object—that is to say a two-dimensional height profile, for instance—is determined on the basis of the calculated two-dimensional regions.

The method step 484 involves determining a joint imaging of the object with an extended depth of field by means of combining those segments of the captured wide-field intermediate images which correspond to the respective two-dimensional regions. In some variants, remaining regions of the captured wide-field intermediate images, which have thus not been sharply imaged in each case, are used for determining colour information for the respective (blurred) regions.

Whereas in the measuring arrangement 100 with regard to FIG. 1 the wide-field intermediate image 86 and the wide-field image 88 coincide—that is to say correspond to one another, for instance—, in the light microscope 200 with regard to FIG. 2 the exactly one wide-field intermediate image 86 or the plurality of wide-field intermediate images 86 differ(s) from the wide-field image 88.

In this case, in some variants, the measuring arrangement 100 with regard to FIG. 1 corresponds to an integral optical measuring arrangement in which the objective 120 and the image capturing device 110 and also, for instance, a distance between the objective 120 and the image capturing area 118 are coordinated with one another in such a way that the object 80 is imaged onto the image capturing area 118 by means of the objective 120 and by the adjustable Fabry-Perot interferometer 114, that is to say that for instance the wide-field intermediate image 86 and the wide-field image 88 correspond to one another and an image plane of the wide-field intermediate image 86 and of the wide-field image 88 extends two-dimensionally along and/or on the image capturing area 118. One advantage of such a set-up may reside in particular in the fact that a smaller number of optical elements—by means of which the object is imaged, for instance—are required in comparison with other measuring arrangements, as a result of which, for instance, a design of the measuring arrangement can be simplified, the measuring arrangement can be set up particularly robustly and/or with a small space requirement and/or a light efficiency—since for instance the light from the object only has to pass through a smaller number of optical elements—can be increased. In some variants, such a measuring arrangement could be employed in an industrial environment—for instance during production for determining a topography, that is to say for instance a two-dimensional height profile and/or a surface constitution, of a product—, wherein a magnification—suitable for determining the topography, for instance—and a distance between the objective and the object are fixedly predefined. For this purpose, in some variants thereof, the control device 140 is configured to carry out a measuring method from FIG. 4, that is to say for instance the measuring method 400. Moreover, it is possible to use ambient light for illuminating the object. Moreover, an optical shielding of the object from ambient light can be avoided since, for instance, no structured illumination is required or illuminating only with specific spectral components of light is required, provided that the illumination light has at least in each case that spectral component which is selected in each case by means of the adjustable Fabry-Perot interferometer.

By contrast, the light microscope 200 with regard to FIG. 2, in some variants, corresponds to a bipartite optical measuring arrangement, wherein firstly the imaging arrangement 220 images an object onto the one or the plurality of wide-field intermediate images 86 and the image capturing device 210—for instance by means of the imaging optics 212—images the one wide-field intermediate image 86 or the plurality of wide-field intermediate images 86 onto the wide-field image 88 and is configured for two-dimensionally capturing said wide-field image 88. In this advantageous way, it is possible to increase a number of possible combinations of parameters and optical elements—such as, for instance, different objects 120, different aberration elements 228 and/or imaging optics 212, for instance for different magnifications, working distances from the respective objective and/or (longitudinal) chromatic aberrations. Moreover, some variants are configured as so-called infinity optics, wherein the imaging arrangement 220 does not generate a real wide-field intermediate image, rather the light from the object, that is to say the light respectively from a starting point of the object, leaves the imaging arrangement 220 as respectively parallel light beams, such that the wide-field intermediate image 86 lies at infinity. For this purpose, some variants comprise a further imaging optical element 221, through which the light emanating from the aberration element 228 is guided. In this advantageous way, a coordination of the imaging arrangement 220 and of the image capturing device 210—for instance of the imaging optics 212—can be independent of an optical path length between the imaging arrangement 220 and the image capturing device 210, as a result of which, for instance, further optical elements can be inserted therebetween without altering and/or disturbing the coordination.

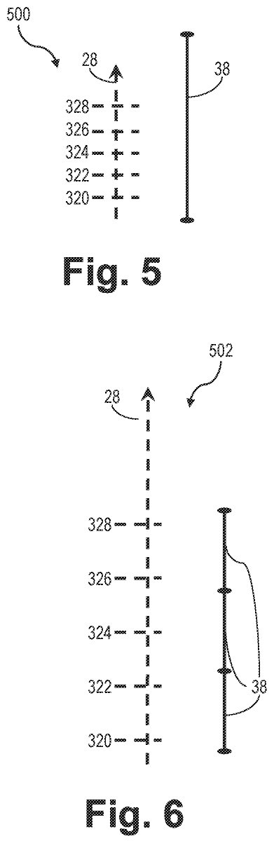

FIG. 5 illustrates embodiments and/or applications of the present invention on the basis of a plurality of different object planes and one range of a depth of field, for instance for achieving an increased resolution.

In one exemplary embodiment 500, the object planes 320, 322, 324, 326 and 328 are arranged, in particular staggered, along a depth axis 28 and are at least substantially orthogonal to the depth axis 28. The range of the depth of field 38 extends along the depth axis 28. In this case, all the object planes 320 to 328 are at most at such a distance from one another with respect to the depth axis 28 that they lie within the range 38, that is to say that, for instance, a maximum height difference between them is smaller than the range of the depth of field 38. In this advantageous way, it is possible to achieve an increased spatial resolution along the depth axis 28.

In some variants, for this purpose, the longitudinal chromatic aberration and a spectral range from which spectral components corresponding to the object planes 320 to 328 are selectable are coordinated with one another in such a way that all the object planes 320 to 328 lie within the range 38.

In variants in which the image capturing device comprises a monochromatic image sensor device, for the purpose of scanning, in each case one spectral component corresponding to one of the object planes 320 to 328 is selected, and light from the object with this spectral component, after filtering, is captured two-dimensionally by means of the monochromatic image sensor device.

In variants in which the image capturing device comprises a colour image sensor device, for the purpose of scanning, in each case a plurality of spectral components corresponding respectively to one of the object planes 320 to 328 are selected simultaneously, and light from the object with these spectral components, after filtering, is simultaneously captured two-dimensionally and in a manner resolved in terms of colour by means of the colour image sensor device, wherein the plurality of spectral components captured simultaneously are distinguishable on the basis of the capturing in terms of colour and, on the basis thereof, are assigned to the respective object planes.

FIG. 6 illustrates embodiments and/or applications of the present invention on the basis of a plurality of different object planes and a plurality of ranges of a depth of field for different wavelengths, for instance for achieving an extended depth of field.

In one exemplary embodiment 502, the object planes 320, 322, 324, 326 and 328 are arranged, in particular staggered, along a depth axis 28 and are at least substantially orthogonal to the depth axis 28. The ranges 38 of the depth of field extend along the depth axis 28, the illustration showing three ranges for three different wavelengths of the light from the object. Furthermore, all the object planes 320 to 328 are at least at such a distance from one another with respect to the depth axis 28 that they are distributed over the plurality of ranges 38, that is to say that, for instance, a maximum height difference between them is larger than respectively one of the ranges, that is to say is greater than the depth of field. In this advantageous way, it is possible—for instance by combining captured images for the object planes—to achieve an extended range for the depth of field, wherein this extended range, that is to say for instance the extended depth of field, extends over a distance range along the depth axis 28 which corresponds to a height difference between the object planes 320 to 328.

In some variants, for this purpose, the longitudinal chromatic aberration and a spectral range from which spectral components and thus wavelengths corresponding to the object planes 320 to 328 or the plurality of ranges 38 are selectable are coordinated with one another in such a way that the object planes 320 to 328 are staggered over the plurality of ranges 38.

Furthermore, in some variants, the longitudinal chromatic aberration, the spectral range and the spectral components are coordinated with one another in such a way that—as illustrated in FIG. 6—in each case at least two of the object planes 320 to 328 lie within one of the plurality of ranges 38. In this advantageous way, it is possible to achieve firstly an extended depth of field and secondly an increased resolution along the depth axis 28.

Some further variants correspond to those with regard to FIG. 5 or exemplary embodiment 500.

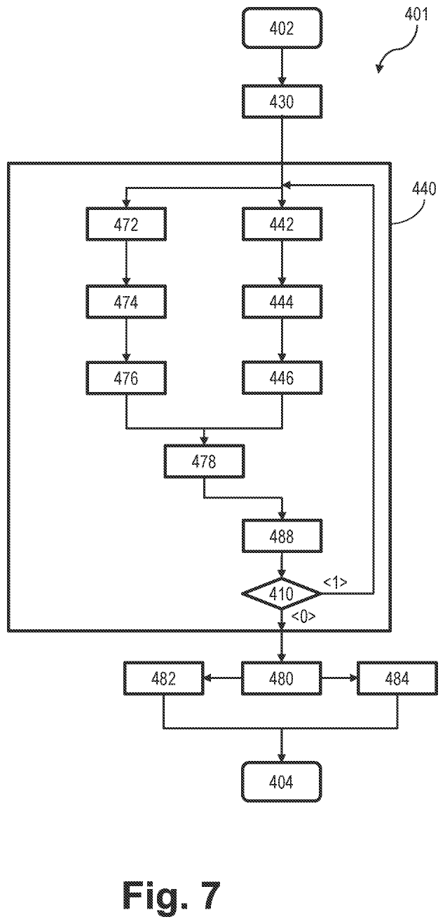

FIG. 7 shows a flow diagram of a measuring method 401 according to a further embodiment of the present invention.

In one exemplary embodiment, the method 401 comprises the method steps 430, 440, 442, 444, 446, 472, 474, 476, 478, 480, 482, 484 and 488 and also the method condition 410. The measuring method 401 begins at the method start 402 and ends at the method end 404.

Method steps and method conditions having the same reference sign correspond to those with regard to FIG. 4.

In this case, the method step 440 furthermore comprises the method steps 472, 474, 476, 478 and 488.

The method steps 472, 474, 476 and 478 may be substeps of a calibration, wherein the latter, in some variants, is carried out in parallel with the capturing of respective object planes.

In the method step 472, light emanating from a calibration object is imaged to form a wide-field intermediate image or is imaged as part of the wide-field intermediate image from method step 442, wherein by means of a longitudinal chromatic aberration a selected object plane of the object planes is imaged sharply for a selected spectral component of the spectral components.

In the method step 474, from the wide-field intermediate image the selected spectral component is filtered—for instance by means of an adjustable interferometer.

In the method step 476, this filtered spectral component of the wide-field intermediate image is captured in an imaging manner two-dimensionally—for instance by means of an image sensor device.

Afterwards, in method step 478, for the calibration object predetermined height information with respect to the respectively captured wide-field intermediate image or a part thereof is assigned to the respective wide-field intermediate image for the object.

Method step 488 involves calculating, on the basis of previously captured wide-field intermediate images and possibly the assigned height information, those two-dimensional regions for which a respective object plane is imaged sharply, and possibly corresponding height information, for instance in order to enable a preview during scanning.

While exemplary embodiments, application possibilities and application examples have been described in detail in particular with reference to the figures, it should be pointed out that a large number of modifications are possible. Moreover, it should be pointed out that the exemplary embodiments and applications are merely examples that are not intended to restrict the scope of protection, the application and the set-up in any way. Rather, the preceding description gives the person skilled in the art a guideline for the implementation and/or application of at least one exemplary embodiment, wherein diverse modifications, in particular alternative or additional features and/or modifications of the function and/or arrangements of the constituent parts described, can be made as desired by the person skilled in the art, without in so doing departing from the subject matter—and the legal equivalents thereof—respectively defined in the appended claims and/or without leaving their scope of protection.

1. A measuring arrangement for imaging depth measurement, comprising:
an imaging arrangement having an objective, said imaging arrangement being configured to image light emanating from an object for a plurality of object planes with respect to the object to form a wide-field intermediate image, wherein by means of a longitudinal chromatic aberration of the imaging arrangement the object planes are staggered depending on a wavelength of the light from the object along a depth axis; and
an image capturing device configured to capture the wide-field intermediate image in an imaging manner and in a manner resolved with respect to one or a plurality of selectable spectral components, each corresponding to one of the object planes.

2. The measuring arrangement according to claim 1, wherein the image capturing device comprises an adjustable Fabry-Perot interferometer for selecting said one or said plurality of spectral components.

3. The measuring arrangement according to claim 2, which furthermore comprises a light entrance region or a light source for illumination light for illuminating the object, wherein the illumination light passes from the light entrance region or light source to the object without passing through the image capturing device or parts thereof.

4. The measuring arrangement according to claim 1, wherein the image capturing device comprises an image sensor device and imaging optics, wherein the imaging optics is configured to image the wide-field intermediate image or the selectable spectral component(s) thereof onto an image plane at the image sensor device as a wide-field image to be captured.

5. The measuring arrangement according to claim 1, wherein the imaging arrangement furthermore comprises an adjustable aberration device, by means of which the longitudinal chromatic aberration of the imaging arrangement is adjustable.

6. The measuring arrangement according to claim 1, wherein the objective has a longitudinal chromatic aberration such that for a wavelength range of the light from the object of 400 nm to 800 nm the object planes are arranged along the depth axis over at least 10 μm.

7. The measuring arrangement according to claim 1, wherein the objective is an achromatic objective and the imaging arrangement furthermore comprises an aberration device, which brings about the longitudinal chromatic aberration of the imaging arrangement.

8. A light microscope for imaging depth measurement, comprising a measuring arrangement according to any of the preceding claims or comprising:
an imaging arrangement having an objective mount for an objective, wherein the imaging arrangement is configured to image light emanating from an object for a plurality of object planes with respect to the object to form a wide-field intermediate image, wherein by means of a longitudinal chromatic aberration of the imaging arrangement the object planes are staggered depending on a wavelength of the light from the object along a depth axis; and
an image capturing device configured to capture the wide-field intermediate image in an imaging manner and in a manner resolved with respect to one or a plurality of selectable spectral components, each corresponding to one of the object planes.

9. A measuring method for imaging depth measurement, wherein the measuring method comprises:
imaging light emanating from an object for a plurality of object planes with respect to the object to form a wide-field intermediate image, wherein by means of a longitudinal chromatic aberration the object planes are staggered depending on a wavelength of the light from the object along a depth axis; and
capturing the wide-field intermediate image in an imaging manner, wherein one or a plurality of selectable spectral components of the light from the object, each corresponding to one of the object planes, are resolved.

10. The measuring method according to claim 9, furthermore comprising:
illuminating a measurement region, wherein the object planes lie within the measurement region;
arranging the object within the measurement region and focussing the object;
scanning a plurality of the object planes, wherein a respective one of the object planes is selected and those spectral components of the wide-field intermediate image which correspond to the respectively selected object plane are captured in an imaging manner;
calibrating the dependence between the object planes and the respective wavelengths by means of a calibration object;
calculating those two-dimensional regions in the wide-field intermediate image respectively captured for a respective wavelength and object plane at which the respective object plane is imaged sharply; and
determining a topography of the object on the basis of the calculated two-dimensional regions and the respective object planes, or determining a joint imaging of the object with an extended depth of field on the basis of combining those segments of the captured wide-field intermediate images which correspond to the respective two-dimensional regions.
